(19) United States
(12) Patent Application Publication
(10) Pub. No.: US 2010/0043652 A1
(43) Pub. Date: Feb. 25, 2010

(54) Rice milling sample machine, for the milling of small sample, 1000g for the determination of quality and milling yield, for the buying and selling of rough rice

(76) Inventor: Danny John Harpole, Jonesboro, AR (US)

Correspondence Address: DANNY JOHN HARPOLE, 2143 HWY 91 WEST, JONESBORO, AR, 72404, US

(21) Appl. No.: 12/077,679

(22) Filed: Mar. 21, 2008

Related U.S. Application Data
(60) Provisional application No. 60/939,918, filed on May 24, 2007.

(51) Int. Cl. B02B 3/00

(52) U.S. Cl. 99/606; 99/600

(57) ABSTRACT

The present invention is an improvement upon such machines as the McGill #3 Rough Rice Milling Machine, and replica models like the McGill #3 Rough Rice Milling, by eliminating the 5 wear points associated with the machine: back plate, rear plate threaded collar, rear plate rings, back plate wear rings and excentric threaded locking nut. Since these five wear areas are of different structural material, back plate: cast aluminum, rear plate: mild steel, eccentric locking nut: cast bronze, the wear rate is not uniform or predictable, thus causing a draft or misalignment of the milling cylinder in the milling basket assembly. The break bars in the Milling Basket Assembly must be in perfect alignment with the shaft that the milling cylinder rotates on. If a misalignment occurs due to wear or uneven wear on the basket assembly then misrepresentative results of the milling yield will occur.

### BACKGROUND OF INVENTION

This invention generally relates to rice milling equipment used in the buying and selling of Rough Rice. Small samples, 1,000 grams of Rough Rice, is first processed by removing the hulls from the kernels and then puttling said brown rice kernel into rice milling machine to determine the quality and milled rice outurn, (milling yield) from said sample of Rough Rice drawn from a lot of Rough Rice.

The present invention is an improvement upon such machines as the McGill #3 Rough Rice milling machine, and repica models like the McGill #3 Rough Rice milling machine, by eliminating the 5 wear points associated with the machine: back plate, rear plate threaded collar, rear plate wear rings, back plate wear rings and excentric threaded locking nut. Since these five wear areas are of different structural material, back plate: cast aluminum, rear plate: mildsteel, excentric locking nut: cast bronze, the wear rate is not uniform or predictable, thus causing a drift or misalignment of the milling cylinder in the Milling Basket Assembly. The break bars in the Milling Basket Assembly must be in perfect alignment with the shaft that the milling cylinder rotates on. If a misalignment occurs due to wear or uneven wear on the Basket Assembly's rear plate, back plate, rear plate threaded collar, rear plate wear rings or excentric threaded cast bronze locking nut, then misrepresentative results of the milling yield will occur. The milling cylinder must be removed from the Milling Basket Assembly and Milling Machine Shaft on a regular basis, and the milling machine shaft has to be gauged to check form misalignment due to wear on the previously mentioned five wear points.

This invention seeks to eliminate the five wear points on the McGill #3 Rough Rice Milling Machine by using a bearing on the new designed rear plate of the improved milling basket assembly and support bearing on the improved front plate of the improved Milling Basket Assembly. Thus eliminating completely the five wear points of the presently used machines. This will produce a Rough Rice Milling Machine that will only have to be gauged when a new screen is installed into the improved Milling Basket Assembly.

This invention seeks to create an improved Milling Basket Assembly design and new designed motor shaft extension, voiding the five wear points that is used in the present milling basket design. A new designed rear plate and improved front plate design of the improved milling basket assembly design will eliminate the five wear points that are a weakness in the machines that are presently in use.

The new designed rear plate of the improved milling basket will be machined (designed) to accept a bearing assembly that will fit snuggly over a (approx.) 2 3/16 new motor shaft design that will be attached to electric motor shaft. The new rear plate design will be machined and drilled to accept a bearing. This new plate design will not have a threaded yoke on it as the presently used rear plate does.

The improved front plate design on the improved milling basket assembly will be machined to accept a (approx.) 1½ inch bearing with an (approx.) ⅝ inch inner bearing race. This will allow for the new designed milling shaft that the milling cylinder fits over to be sized and to fit snuggly into the bearing in the improved front plate of the improved milling basket assembly. Thus providing support for the milling cylinder when down pressure is applied to the basket cover during the milling process.

### DESCRIPTION OF THE INVENTION

My invention consists in the construction, arrangements, and combination, of the various parts of the device, whereby the objects contemplated are attained as hereinafter more fully set forth, specifically pointed out in my claims, and illustrated in the accompanying drawings, in which:

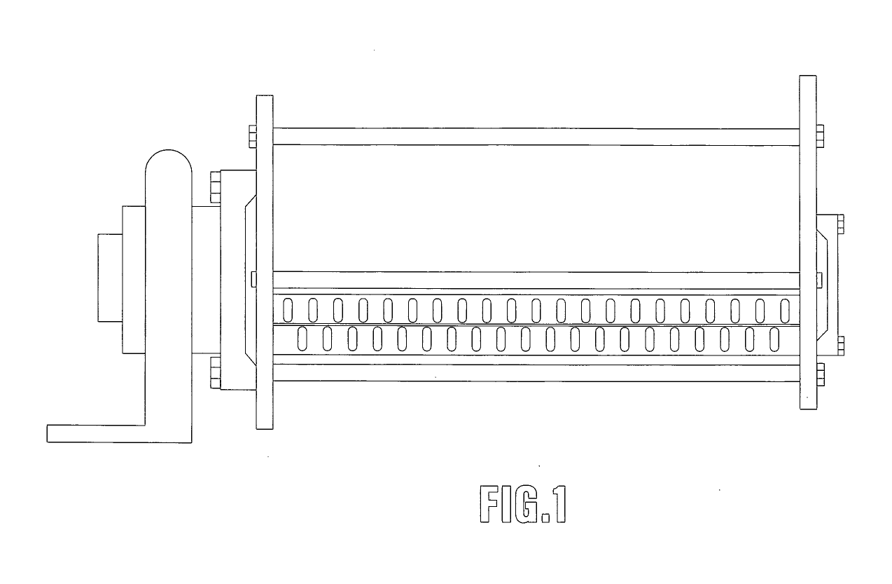

FIG. 1 is a side view of the Milling Basket Assembly with back plate,

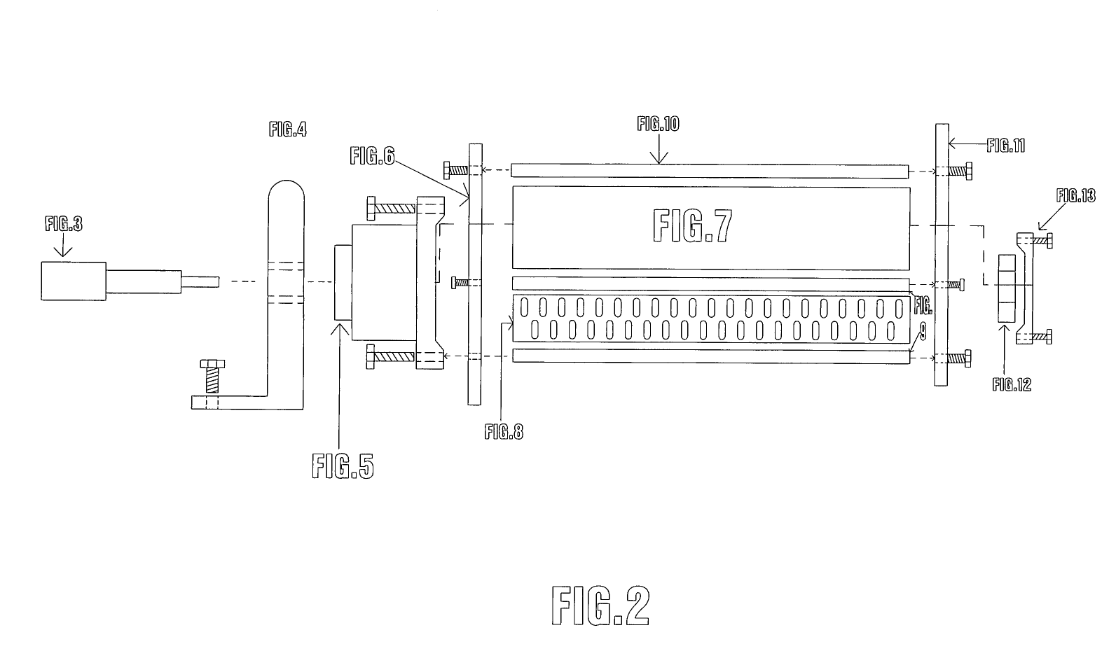

FIG. 2 is a more fully illustrated exploded view of the Milling Basket Assembly with back plate,

FIG. 3 is new designed motor shaft extension that fits over motor shaft, helt firmly in place by motor shaft key and threaded locking screws,

FIG. 4 is back plate, used only for stop for Milling Basket Assembly,

FIG. 5 is rear end plate bearing that is attached by threaded bolts to designed rear end plate, bearing is also attached to designed motor shaft extension shaft by four locking set screws,

FIG. 6 designed rear end plate of Milling Basket Assembly, designed rear end plate is designed to accepct bearing and hold said bearing in place to designed rear end plate,

FIG. 7 is the milling cylinder, fits over FIG. 3 designed motor shaft extension rotating clockwise during milling process,

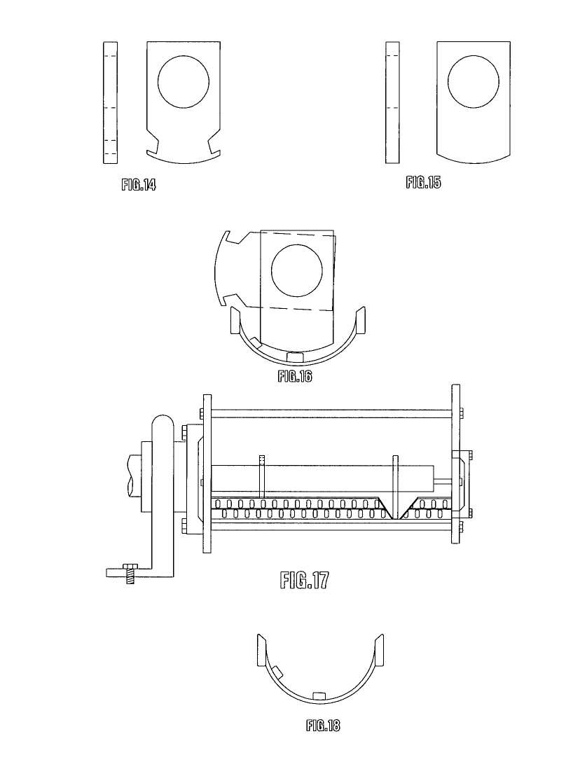

FIG. 8 milling basket screen allows by product of milling process to pass through screen and not remain in milled sample of rice,

FIG. 9 shows lower spacer bars (4), these spacer bars are drilled and tapped on each end so that threaded bolts can be inserted through designed front plate, designed rear plate, along with,

FIG. 10 lever spacer bar, to draw up tight and hold together the design front plate and design rear plate thus holding securely in place the milling basket screen between the designed front end plate and designed rear end plate,

FIG. 11 designed front end plate, designed to accept FIG. 13 designed front end plate bearing assembly to hold,

FIG. 12 bearing in designed front end plate bearing assembly,

FIG. 13 designed front end plate bearing assembly,

FIG. 14 shows side and frontal view of gauge used to determine side to side tolerance in Milling Basket Assembly,

FIG. 15 shows side and frontal view of gauge used to determine the correct depth of milling screen in Milling Basket Assembly,

FIG. 16 shows the correct relations of side to side depth of milling screen to designed motor shaft extension,

FIG. 17 shows a milling screen being correctly gauged with side to side tolerance gauge and depth tolerance gauge,

Note: the milling screen is gauged from the designed milling shaft extension

FIG. 18 is a frontal view of milling screen used in Milling Basket Assembly,

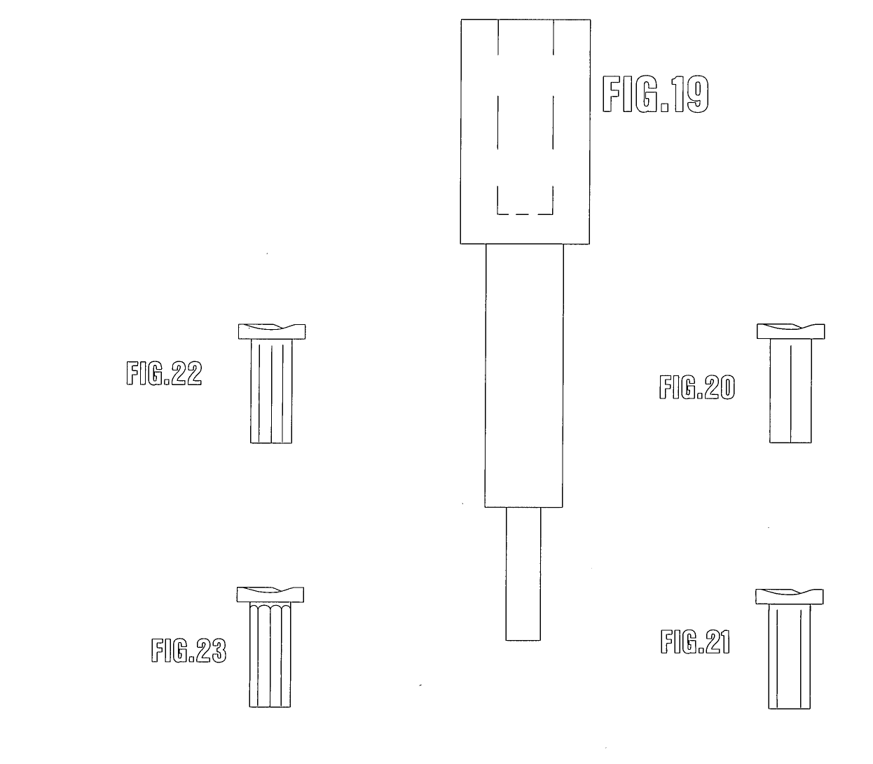

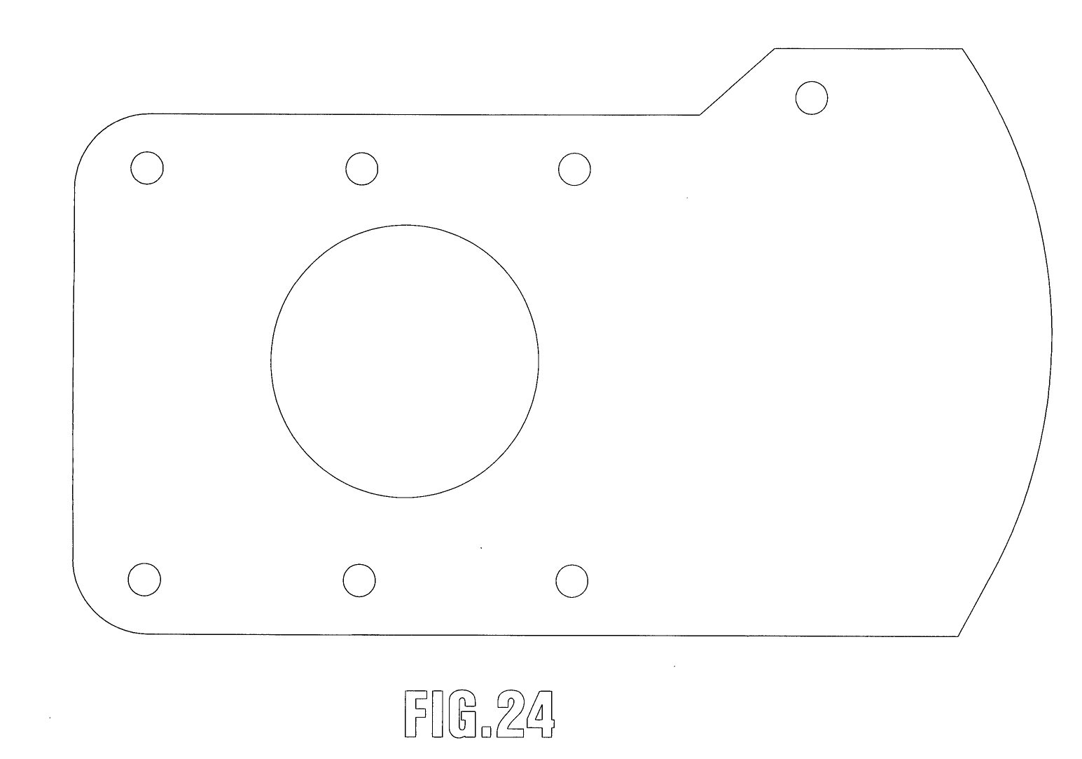

FIG. 19-23 shows the designed motor shaft extension with various tip end configurations to fit into bearing end design, front end plate bearing assembly,

FIG. 24 front view of designed rear plate, designed to accept rear plate bearing so as to allow, design motor shaft extension to rotate in design rear plate,

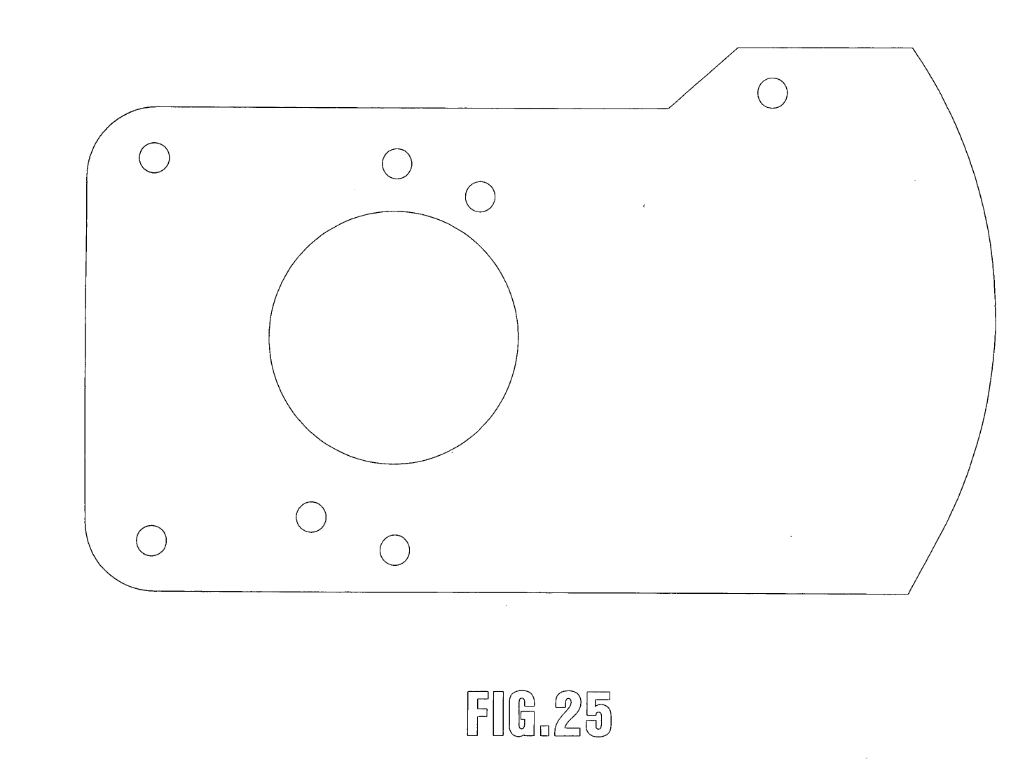

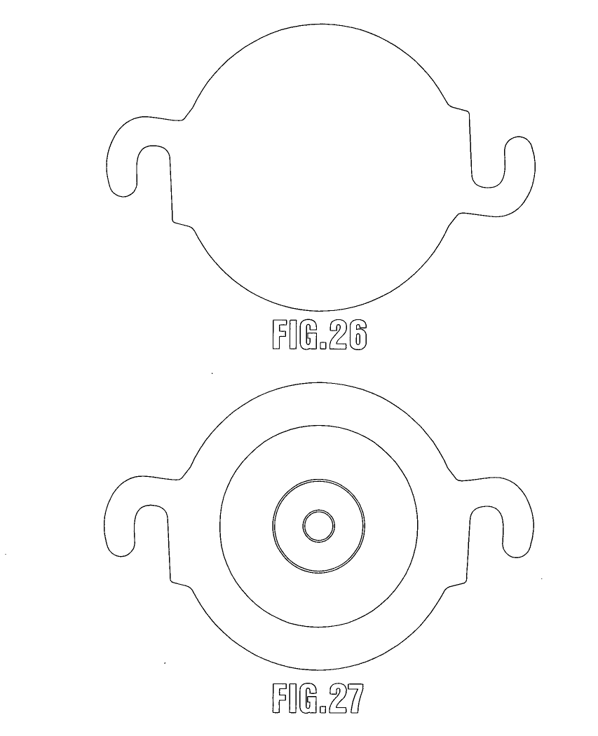

FIG. 25 front view designed front end plate machined to allow designed front end plate bearing assembly to fit snuggly into designed front end plate, thus with designed front end plate bearing assembly installed, with bearing into designed front end plate, the tip of the designed motor shaft extentsion rests firmly in bearing in designed front end plate assembly which is installed into designed front end plate, allowing the rotation of designed motor shaft extension in Milling Basket Assembly,

FIG. 26 front view of designed front end plate bearing assembly designed to fit snuggly into designed front end plate

FIG. 27 inward view, view from within the Milling Basket Assembly showing bearing that tip of designed motor shaft extension will ride in thus allowing rotation of designed motor shaft extension in designed front end bearing assembly.

The object of this invention is to create a Milling Basket Assembly that rides freely on the motor shaft extension during the milling process, eliminating the before mentioned problems or wear that cause misalignment and are inherit in other designs. A further objective is create a milling basket assembly that can be moved from one motor shaft extension to another motor shaft extension without losing correct motor shaft alignment or milling basket screen tolerance, since the Milling Basket Assembly front and rear plate have attached bearings through which the motor shaft extension is inserted then moving the milling basket from one electric motor with motor shaft extension to another electric motor with like extensions, then shaft alignment and milling screen tolerance are maintatined thus alignment of motor shaft extension and milling basket tolerance will remain constant through out the life of the Milling Basket Assembly.

The present invention relates to an Improved Rice Milling Sample Machine. For the milling of small sample, 1,000 g for the determination of quality and milling yield, for the buying and selling of rough rice. This device is comprised of the following components:
(1.) An improved milling basket and motor shaft extension design:
   (a.) a design that eliminates the 5 wear points that are associated with the present design
   (b.) a design that eliminates the threaded collar on the present design, this improved milling basket will be designed to accept a bearing, designed to accept both load and thrust from the new milling basket rear plate design.
(2.) A new milling basket rear plate, designed to accept a bearing for support of the new improved milling basket on the new motor shaft design.
(3.) A new motor shaft design:
   (a.) will be approx. 12 inches with collar of approx. 2 3/16 inches will fit over the 1⅛ inches power shaft that extends from the electric motor.
   (b.) will fit snuggly into the bearing attached to the new designed milling basket rear plate, thus eliminating the present threaded collar on the milling basket rear plate that is pulled up tight, against the back plate by the brass eccentric collar.
   (c.) will have an approx. ⅝ shaft in diameter to fit snuggly into a new bearing assembly design for the improved front end plate on the milling assembly.
(4.) An improved front end plate design for the improved milling basket assembly, this improved front end plate will be designed to accept the new designed front end plate bearing assembly.
(5.) A new front end plate bearing assembly designed to fit snuggly with the improved milling basket front end plate.
   (a.) will fit snuggly into the improved milling basket front ent plate design.
   (b.) will have a bearing that fits snuggly into a machined out hole in the new bearing front end plate.
   (c.) will fit snuggly into improved front end plate and over said new motor.

This invention will create a new improved milling basket design that will eliminate the present weakness of the design that is presently being used.

This device could be used to mill smaller samples that 1,000 grams by designing a smaller milling basket assembly.

### DESCRIPTION OF MILLING

(1.) Definition: Milling is the removal of practically all of the germs and bran layers from kernels of rice.
(2.) Basis: The rice that remains after shelling.
(3.) Method: by use of an approved miller.

### DESCRIPTION OF MILLING PROCESS

(1.) When the miller is used, warm the miller as follows;
   (a.) place approx. 750 grams of milled rice in the milling chamber with a 2-pound weight on the weight holder.
   (b.) make three consecutive 30 second runs.
   (c.) throughly clean the machine.
(2.) Proceed with the milling, using a two-bar, 3/64 inch oblong screen.
   (a.) Set the timer switch at exactly 30 seconds.
   (b.) Tilt the chamber so that the rice will flow uniformly beneath the milling cylinder, and pour the entire sample of shelled rice into the milling chamber.
   (c.) Close the milling chamber, and return it to the milling position.
   (d.) Position the saddle and weight arm on the milling chamber.
   (e.) Position the weight holder on the weight arm.
   (f.) Position the prescribed weight on the weight holder rice to be milled as follows
      1. Prescribed Weights:
         Long Grain—2 pounds
         Medium Grain—7 pounds
         Short Grain—12 pounds
      2. For mixtures of rice, use the weight prescribed for the type of rice that predominates the mixture.
   (g.) Start the machine for the 30 second run.
   (h.) After milling, remove the weight from the weight holder.
   (i.) Start the machine for the 2nd 30 second run.
   (j.) After brushing, remove the weight holder, weight arm, and saddle.
   (k.) Clean the machine and the hopper.
   (i.) Place the container under the hopper opening and transfer the rice from the milling chamber in to the container.

NOTE: To prevent the possibility of the rice becoming cracked (commonly referred to as “Checking”) due to change in temperature, allow the sample to cool before removing it from the container.

I claim:

1. An improved milling basket assembly design:
(a.) an improved milling basket assembly design that eliminates the 5 wear points that are associated with the present design.
(b.) improved milling basket assembly design will be supported by a bearing on the new milling basket rear plate and bearing in new bearing assembly that fits snuggly into the improved milling front plate by sliding over new motor shaft extension design.

2. A New Milling Basket Rear Plate Design, that eliminates the threaded collar on the present design, this improved milling basket will be designed to accept a bearing, designed to accept both load and thrust load from the new milling basket rear plate design.

3. An improved milling basket front end plate design for the improved milling basket assembly, this improved front end plate will be designed to accept the new designed front end plate bearing assembly.

4. A new front end bearing plate assembly designed to fit snuggly with the improved milling basket front end plate:
(a.) new front end bearing plate assembly will fit snuggly into the improved milling basket front end plate design
(b.) bearing plate assembly will have a bearing that fits snuggly into a machined out hole in the new bearing front end plate assembly.

5. A new motor shaft extension design:
(a.) a new motor shaft design will be approx. 12 inches with a collar of approx. 2 3/16 inches that will fit over the 1⅛ inches power shaft that extends from the electric motor
(b.) new motor shaft design will fit snuggly into the bearing attached to the new designed milling basket rear plate, thus eliminating the present threaded collar on the milling basket rear plate that is pulled up tight, against the back plate by the brass excentric threaded collar nut
(c.) new motor shaft design will be machined to have approx. ⅝ shaft in diameter to fit snuggly into a new bearing assembly design for the improved front end plate on the improved milling basket assembly.
